(19) United States
(12) Patent Application Publication
(10) Pub. No.: US 2012/0027894 A1
(43) Pub. Date: Feb. 2, 2012

(54) LIGNAN FLAX SEED CAKES

(76) Inventor: Walt Osborn, Blackfoot, ID (US)

(21) Appl. No.: 13/195,857

(22) Filed: Aug. 2, 2011

Related U.S. Application Data
(60) Provisional application No. 61/369,823, filed on Aug. 2, 2010.

(51) Int. Cl. A21D 8/02; A21D 2/38; A23L 1/36; A21D 2/08; A21D 10/00; A21D 13/00; A21D 8/06

(52) U.S. Cl. 426/94; 426/550; 426/502

(57) ABSTRACT

Lignan Flax Seed Cakes offers consumers a delicious and simple way to consume ground flax seed. This product combines multiple healthy ingredients, such as fruit, oats, and walnuts, with ground flax seed to produce a well-textured and desirable food item. This comestible food product enables individuals to receive a known (controlled) quantity of flax seed, while simultaneously consuming other beneficial ingredients. The enjoyable taste makes it easy to obtain the health benefits provided by flax seed within a consumer's diet.

### CROSS-REFERENCE TO RELATED APPLICATION

The present application is related to and claims priority from prior provisional application Ser. No. 61/369,823, filed Aug. 2, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of nutritional foodstuffs and more specifically relates to nutritional cakes and cookie having ground flax seed.

2. Description of the Related Art

Individuals in modem society often have poor diets leading to obesity and health problems. Although individuals attempt to prepare healthy meals often the food is tasteless or unpleasant to eat. Flax, a known healthy oilseed, is grown both for its seeds and for its fibers. Flax seed is the source of linseed oil and may be useful as an edible oil, and/or as a nutritional supplement. Flax seed may be bland in taste, thus not desirable to eat by itself.

Flax seeds come in two basic varieties: (1) brown; and (2) yellow or golden. Most types have similar nutritional characteristics and equal amounts of short-chain omega-3 fatty acids. The exception is a type of yellow flax called solin, which has a completely different oil profile and is very low in omega-3 FAs. Although brown flax can be consumed as readily as yellow, and has been for thousands of years, it is better known as an ingredient in paints, fiber and cattle feed. Flax seeds produce a vegetable oil known as flaxseed or linseed oil.

Flax seeds contain high levels of dietary fiber as well as Lignans, an abundance of micronutrients and omega-3 fatty acids (table). Flax seeds may lower cholesterol levels, especially in women. Studies suggest that flax seeds taken in the diet may benefit individuals with certain types of breast and prostate cancers. Flax may also lessen the severity of diabetes by stabilizing blood-sugar levels. There is some support for the use of flax seed as a laxative due to its dietary fiber content although excessive consumption without liquid can result in intestinal blockage. Consuming large amounts of flax seed may impair the effectiveness of certain oral medications, due to its fiber content, and may have adverse effects due to its content of neurotoxic cyanogen glycosides and immunosuppressive cyclic nonapeptides. One of the main components of flax is Lignan, which has plant estrogen as well as antioxidants; flax contains up to 800 times more Lignans than other plant foods contain.

Ground flax seed is known to have many health benefits, such as reducing cholesterol and blood pressure. Currently, flax seed is sold in select grocery stores and health food outlets. Ground flax seed is often mixed with cereal, cottage cheese, or in fruit smoothies. The process of mixing the flax seed can become tedious. Presently, there are a limited number of foods that are accommodating to ground flax seed. A comestible option is needed whereby consumers could enjoy the nutritional benefits of flax seed in a delicious food, and such that the proper proportions of the flax seed could be ingested to maintain the consumer's health.

Various attempts have been made to solve the above-mentioned problems such as those found in U.S. Pub. And U.S. Pat. Nos. 2005/0249860; 5,612,074; 2005/0287264; 2003/0072862; 2006/0159833; and 2005/0147725. This prior art is representative of flax seed use in dietary comestibles. None of the above inventions and patents, taken either singly or in combination, is seen to describe the invention as claimed.

Ideally, a Lignan flax seed cake should be nutritional, palatable and be easy to prepare, yet be made at a modest expense. Thus, a need exists for a reliable Lignan flax seed cake system to provide nutrition and to avoid the above-mentioned problems.

### BRIEF SUMMARY OF THE INVENTION

In view of the foregoing disadvantages inherent in the known nutritional cakes and comestibles art, the present invention provides a novel Lignan flax seed cake system. The general purpose of the present invention, which will be described subsequently in greater detail is to provide a nutritional and appetizing means for intaking flax seed into a consumer's diet.

Lignan flax seed cakes offers consumers a delicious and easy way to consume ground flax seed. This product combines multiple healthy ingredients, such as fruit, oats, and walnuts, with ground flax seed to produce a well-textured and desirable food item. This product enables individuals to receive a known quantity of flax seed, while simultaneously consuming other beneficial ingredients. The enjoyable taste makes it easy to obtain the health benefits provided by flax seed. A recipe and method of preparation are disclosed within the present document. Other nuts may be used however walnuts are preferable because they are less expensive and are beneficial health-wise.

The recipe(s) is/are as follows:

Mix together in large mixing bowl: 1 cup dark semi-sweet chocolate chips; 5 cups flax seed; ground 1 cup pumpkin seeds, ground; ½ cup grated coconut; 1 cup walnuts, chopped; 2 cups rolled oats; 1 teaspoons baking powder; 1½ teaspoon baking soda; and 1 teaspoon salt.

Mix together in separate bowl: 1 cup chopped dried cranberries; 1 cup olive oil; 3 eggs; and 1 teaspoon vanilla.

Add to dry ingredients and then add: 2 cups honey.

Roll out dough ¼″ thick on wax paper and cut into 2½″ rounds. Place on baking sheet and bake at 375° F. for 8-10 minutes or until lightly browned and cooked through.

For bar cookies press dough out ¼″ thick on a large cookie sheet or jelly roll pan. Bake at 375° F. for 20 minutes or until done. Cool and cut into cookies. Makes approximately 5 dozen cakes.

Option: To make into a cake add 1 cup of water or juice and change baking powder to 1 tablespoon. Place in cake pan and bake at 375° F. for 20-30 minutes or until done.

The present invention holds significant improvements and serves as a Lignan flax seed cake and/or cookies system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, lignin flax seed cake, constructed and operative according to the teachings of the present invention.

FIG. 1 shows a perspective view illustrating cookies (upper) and a Lignan flax seed cake (lower) according to embodiments of the present invention.

FIG. 2 is a flowchart illustrating method(s) of preparation (making and baking Lignan flax seed cake and cookies) according to embodiments of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a nutritional recipes and more particularly to a nutritional recipe and method of preparation as used to improve the palatability of flax seed within baked comestibles.

Generally speaking, Lignan flax seed cakes of the present invention provides consumers with a delicious and efficient means to consume ground flax seed on a regular basis. This product also preferably combines multiple healthy and tasty ingredients, such as fruit, oats, and walnuts, with the ground flax seed to produce a well-textured and desirable comestible. This product enables individuals to receive a controlled quantity of flax seed, while simultaneously consuming other beneficial ingredients. The novel recipe provided is tasty making it easy to realize the health benefits provided by ingestion of flax seed.

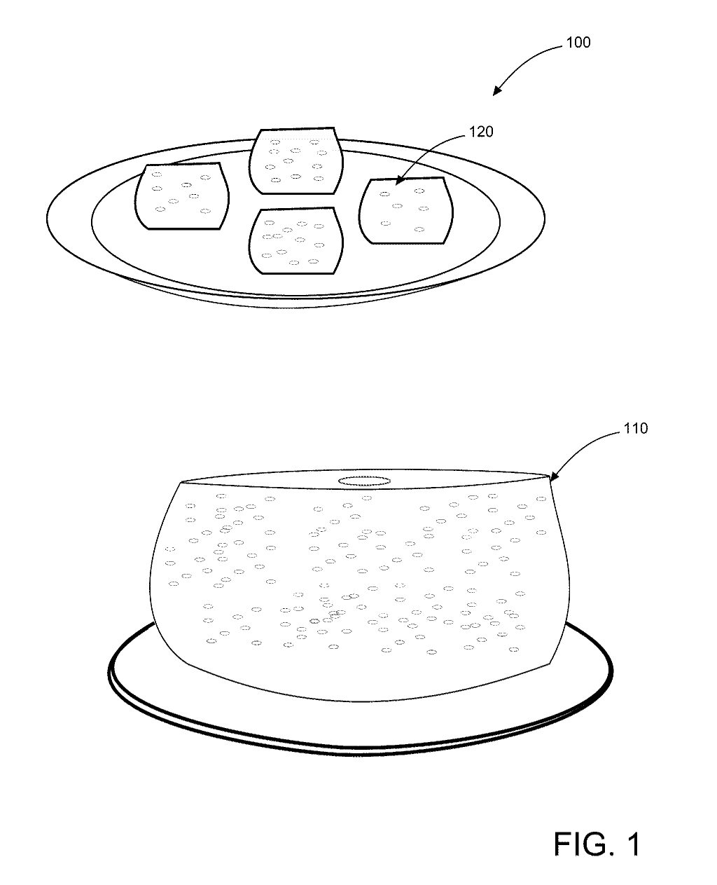

Referring to the drawings by numerals of reference there is shown in FIG. 1 a perspective view illustrating cookies 120 and Lignan flax seed cake 110 according to an embodiment of the present invention. Cookies 120 are illustrated in the top figure and Lignan flax seed cake 110 in the bottom figure, both embodiments of the present invention that may be made according to user preference.

A recipe for lignin flax seed cake system 100 comprises ingredients combined in proportions substantially including: 1 cup of dark semi-sweet chocolate chips; 5 cups of ground flax seed; 1 cup of ground pumpkin seeds; ½ cup of grated coconut; 1 cup of chopped walnuts; 2 cups of rolled oats; 1 teaspoon of baking powder; 1½ teaspoon of baking soda; and 1 teaspoon of salt; wherein lignin flax seed cake 110 is prepared by intermixing the 1 cup of dark semi-sweet chocolate chips; 5 cups of ground flax seed; 1 cup of ground pumpkin seeds; ½ cup of grated coconut; 1 cup of chopped walnuts; 2 cups of rolled oats; 1 teaspoon of baking powder; 1½ teaspoon(s) of baking soda; and 1 teaspoon of salt in a large mixing bowl. The disclosed measures may be modified according to a desired end product. Upon reading this specification, it should be appreciated that, under appropriate circumstances, considering such issues as user preferences, design preference, structural requirements, marketing preferences, cost, available materials, technological advances, etc., other ingredients and mixing arrangements such as, for example, other fruits, seeds, vegetables, supplements, etc., may be sufficient. Additionally, all measurements (in the present application) are considered ‘approximate measurements’ and are not to be construed as exacting, thus slightly different measurements will still be considered within the scope of the present invention.

The following ingredients are preferably intermixed in a separate mixing bowl: 1 cup of chopped dried cranberries; 1 cup of olive oil; 3 eggs; and 1 teaspoon vanilla; wherein the measures may also be modified according to the desired end product. These ingredients are mixed and then added to the dry ingredients mentioned in the previous paragraph. Lignin flax seed cake system 100 may further comprise 2 cups of honey which is preferably added at this juncture.

Mixture of Lignin flax seed cake system 100 is next rolled out as dough about ¼″ thick preferably on wax paper and is cut into about 2½″ rounds (for cookie(s) 120 embodiment—as shown in top illustration on FIG. 1), then placed on a baking sheet and baked at about 375° F. for about 8-10 minutes (depending on actual oven temperature, altitude, and other contributing environmental factors) or until lightly browned and cooked through (according to consumer-preference.) For bar versions of cookies 120 the baker may press the dough out ¼″ thick on a large cookie sheet or a jelly roll pan. Then the mixed recipe is baked at about 375° F. for about 20 minutes or until done. The baked product is then allowed to cool in ambient conditions and cut into cookies 120. In this way the present invention of Lignan flax seed cake 110 is in the form of at least one cookie 120; wherein cookies 120 may be conveniently carried in lunches for example to provide a convenient means for ingesting nutritional flax seed and the other above-mentioned ingredients throughout the day. The disclosed recipe makes approximately 5 dozen cakes. It should be appreciated that the recipe may be altered accordingly to make more or less of the final comestible product.

Alternately, Lignan flax seed cake 110 (as shown in the lower portion of FIG. 1) may be made by adding 1 cup of water or juice and changing (increasing) the 1 teaspoon of baking powder to 1 tablespoon of baking powder. The mixture is then placed in a cake pan and baked at about 375° F. for about 20-30 minutes or until done.

Lignin flax seed cake system 100 may be sold as kit 440 comprising the above-mentioned ingredients in a package; and a recipe such that a consumer may mix and bake the ingredients for consumption. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less or different ingredients, different recipes, etc., may be sufficient.

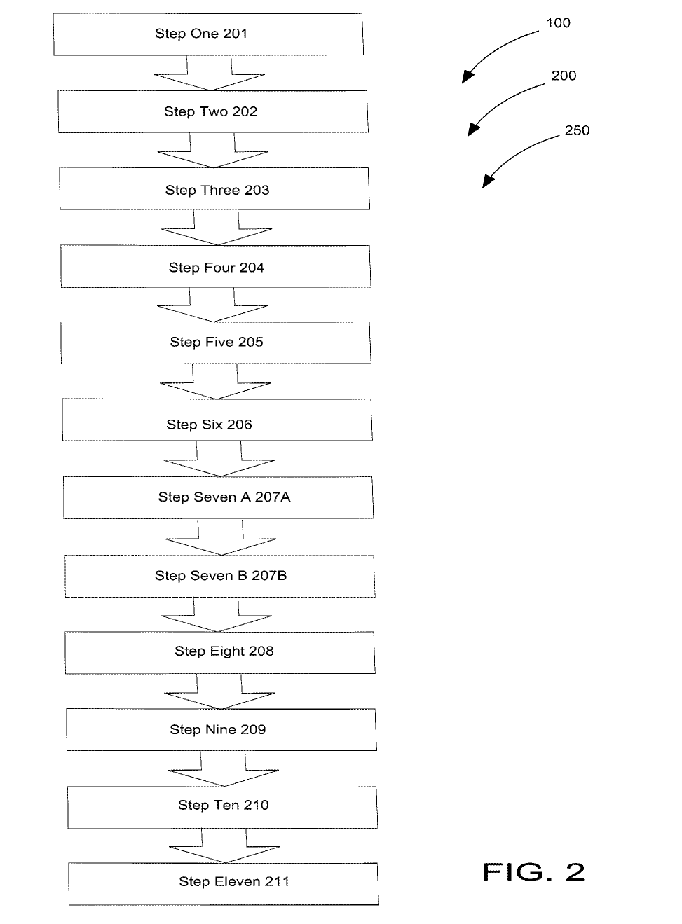

FIG. 2 is a flowchart 250 illustrating a method of preparation 200 (making and baking) Lignan flax seed cake 110 and/or cookies 120 according to an embodiment of the present invention of FIG. 1.

A method of preparing comestibles (at least hereby enabling method of preparation 200) using Lignan flax seed cake system 100 to produce a nutritional snack preferably comprises the steps of: step one 201 intermixing 1 cup dark semi-sweet chocolate chips; 5 cups ground flax seed; 1 cup ground pumpkin seeds; ½ cup grated coconut; 1 cup chopped walnuts; 2 cups rolled oats; 1 teaspoons baking powder; 1½ teaspoon baking soda; and 1 teaspoon salt in a large mixing bowl creating a dry mixture; step two 202 intermixing 1 cup chopped dried cranberries; 1 cup olive oil; 3 eggs; and 1 teaspoon vanilla are intermixed in a separate bowl thereby producing a semi-liquid mixture; step three 203 pouring the semi-liquid mixture into the dry mixture in the large mixing bowl; step four 204 adding 2 cups of honey to the semi-liquid mixture and the dry mixture once the semi-liquid mixture and the dry mixture are mixed together, thereby producing a Lignan flax seed dough. Next step five 205 comprises rolling out the Lignan flax seed dough about one-fourth inch thick on wax paper; step six 206 cutting the Lignan flax seed dough into about 2½″ rounds (cookies 120); step seven 207a placing the Lignan flax seed dough on a baking sheet (for cookies 120; Lignan flax seed cake 110 is (poured) placed into a cake pan); step eight 208 baking the Lignan flax seed dough at about 375° F. for about 8-10 minutes (for cookies 120) (20-30 minutes for Lignan flax seed cake 110) or until lightly browned and cooked through; step nine 209 removing the Lignan flax seed product from the oven; step ten 210 cooling the Lignan flax seed product of Lignin flax seed cake system 100; and step eleven 211 consuming or storing the final baked product of Lignin flax seed cake system 100. To make into a cake add 1 cup of water or juice (to thin the mixture) and change (increase) baking powder measure to 1 tablespoon. Place the ‘wet’ (thinned consistency) mixture in a cake pan and bake at about 375° F. for about 20-30 minutes (as mentioned above) or until done.

A method of preparing a Lignan flax seed cake system (method of preparation 200) in the form of cookies 120 may further comprises the step 207b of cutting the Lignan flax seed dough into cookies 120.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A recipe for a lignin flax seed cake system comprising ingredients combined in proportions substantially including:
1 cup dark semi-sweet chocolate chips;
5 cups ground flax seed;
1 cup ground pumpkin seeds;
½ cup grated coconut;
1 cup chopped walnuts;
2 cups rolled oats;
1 teaspoons baking powder;
1½ teaspoon baking soda; and
1 teaspoon salt;
wherein said lignin flax seed cake is prepared by intermixing said 1 cup dark semi-sweet chocolate chips; said 5 cups ground flax seed; said 1 cup ground pumpkin seeds; said ½ cup grated coconut; said 1 cup chopped walnuts; said 2 cups rolled oats; said 1 teaspoons baking powder; said 1½ teaspoon baking soda; and said 1 teaspoon salt in a large mixing bowl; and
wherein measures may be modified according to a desired end product.

2. The lignin flax seed cake system of claim 1 wherein said ingredients further comprise and are intermixed in a separate mixing bowl:
1 cup chopped dried cranberries;
1 cup olive oil;
3 eggs; and
1 teaspoon vanilla; and
wherein said measures may be modified according to the desired end product.

3. The lignin flax seed cake system of claim 1 wherein said ingredients further comprises 2 cups of honey, said honey is added after mixing said ingredients in said separate mixing bowl and said ingredients in said large mixing bowl.

4. The lignin flax seed cake system of claim 3 wherein said lignin flax seed cake system is placed on a baking sheet and baked at 375° F. for about 8-10 minutes or until lightly browned and cooked through.

5. The recipe for a Lignan flax seed cake system of claim 1 wherein said Lignan flax seed cake is in the form of a cookie.

6. The recipe for a Lignan flax seed cake system of claim 5 wherein said Lignan flax seed cake is made by adding 1 cup of water or juice and changing said 1 teaspoon baking powder to 1 tablespoon of baking powder to produce a wet mixture.

7. The recipe for a Lignan flax seed cake system of claim 6 wherein said Lignan flax seed cake is made by placing said wet mixture in a cake pan and baking at about 375° F. for about 20-30 minutes or until done.

8. A recipe for a lignin flax seed cake system comprising ingredients combined in proportions substantially including:
1 cup dark semi-sweet chocolate chips;
5 cups ground flax seed;
1 cup ground pumpkin seeds;
½ cup grated coconut;
1 cup chopped walnuts;
2 cups rolled oats;
1 teaspoons baking powder;
1½ teaspoon baking soda;
1 teaspoon salt;
1 cup chopped dried cranberries;
1 cup olive oil;
3 eggs;
1 teaspoon vanilla; and
2 cups honey;
wherein said lignin flax seed cake is prepared by intermixing dry ingredients of said 1 cup dark semi-sweet chocolate chips; said 5 cups ground flax seed; said 1 cup ground pumpkin seeds; said ½ cup grated coconut; said 1 cup chopped walnuts; said 2 cups rolled oats; said 1 teaspoons baking powder; said 1½ teaspoon baking soda; and said 1 teaspoon salt in a large mixing bowl creating a dry mixture;
wherein said 1 cup chopped dried cranberries; said 1 cup olive oil; said 3 eggs; and said 1 teaspoon vanilla are intermixed in a separate bowl thereby producing a semi-liquid mixture;
wherein said semi-liquid mixture is poured into said dry mixture in said large mixing bowl;
wherein said 2 cups of honey is added to said semi-liquid mixture and said dry mixture once they are mixed together thereby producing said Lignin flax seed dough; and
wherein said measures may be modified according to a desired end product.

9. A method of preparing a Lignan flax seed cake system as cookies comprising the steps of:
intermixing 1 cup dark semi-sweet chocolate chips; 5 cups ground flax seed; 1 cup ground pumpkin seeds; ½ cup grated coconut; 1 cup chopped walnuts; 2 cups rolled oats; 1 teaspoons baking powder; 1½ teaspoon baking soda; and 1 teaspoon salt in a large mixing bowl creating a dry mixture;
intermixing 1 cup chopped dried cranberries; 1 cup olive oil; 3 eggs; and 1 teaspoon vanilla which are intermixed in a separate bowl thereby producing a semi-liquid mixture;
pouring said semi-liquid mixture into said dry mixture in said large mixing bowl;
adding 2 cups of honey to said semi-liquid mixture and said dry mixture once said semi-liquid mixture and said dry mixture are mixed together thereby producing a Lignan flax seed dough;
rolling out said Lignan flax seed dough about one-fourth inch thick on wax paper;
cutting said Lignan flax seed dough into about 2½″ rounds to form said cookies;
placing said Lignan flax seed dough on baking sheet;
baking said Lignan flax seed dough as said cookies at about 375° F. for about 8-10 minutes or until lightly browned and cooked through;
removing said cookies from oven;
cooling said cookies of said lignin flax seed cake system; and
consuming said cookies of said lignin flax seed cake system.

10. A method of preparing a Lignan flax seed cake system in the form of Lignan flax seed cake comprising the steps of:
intermixing 1 cup dark semi-sweet chocolate chips; 5 cups ground flax seed; 1 cup ground pumpkin seeds; ½ cup grated coconut; 1 cup chopped walnuts; 2 cups rolled oats; 1 tablespoon baking powder; and 1 teaspoon salt in a large mixing bowl creating a dry mixture;
intermixing 1 cup chopped dried cranberries; 1 cup olive oil; 3 eggs; 1 teaspoon vanilla; and 1 cup of water in a separate bowl thereby producing a semi-liquid mixture;
pouring said semi-liquid mixture into said dry mixture in said large mixing bowl;
adding 2 cups of honey to said semi-liquid mixture and said dry mixture once said semi-liquid mixture and said dry mixture are mixed together thereby producing a Lignan flax seed dough;
adding 1 cup of water or juice to thin consistency creating a wet mixture;
placing said wet mixture in a cake pan;
baking said Lignan flax seed dough at about 375° F. for about 20-30 minutes or until lightly browned and cooked through;
removing said Lignan flax seed cake system from oven and cooling; and
consuming said Lignan flax seed cake.
